(19) United States
(12) Patent Application Publication
(10) Pub. No.: US 2012/0236742 A1
(43) Pub. Date: Sep. 20, 2012

(54) Method/apparatus for transporting two or more asynchronous data streams over a single data link

(76) Inventors: Kenneth R. Herrity, Milpitas, CA (US); Eric Grann, Danville, CA (US); Ray Curtis, Alamo, CA (US)

(21) Appl. No.: 13/385,879

(22) Filed: Mar. 12, 2012

Related U.S. Application Data
(60) Provisional application No. 61/465,088, filed on Mar. 14, 2011.

(51) Int. Cl. H04L 12/26

(52) U.S. Cl. 370/252

(57) ABSTRACT

A method and apparatus for locking transmit data rates to respective, arbitrary receive data rates in a system that transports two or more video, audio or general data streams over a single data link.

### CROSS REFERENCE TO RELATED APPLICATION

This application claims the benefit of and priority from U.S. provisional application Ser. No. 61/465,088 filed Mar. 14, 2011.

### BACKGROUND

The present invention relates generally to the transport of two or more data streams, such as video streams, over a single data link. More particularly, the invention relates to the transport of two or more video, audio or general data streams over a single serial link. The invention also provides a novel Buffer Locked Loop useful in transporting general data streams.

When transporting a video stream, it is essential that the Frame Rate at the Transmit Module is exactly equal to the frame rate at the Receive Module. This problem is complicated by 2 factors:
1. Video data is usually continuous. There are no bits or symbols in a video stream that may be discarded (or inserted) and there are no gaps in a video stream. Video standards such as SDI do not permit the insertion/deletion of video pixels at any time including the horizontal and vertical blanking intervals. This means that traditional rate matching techniques (such as idle insertion/deletion) may not be used.
2. The reference clock at the Transmit and Receive Modules are usually not exactly the same.

For a system that is transporting a single video stream, this problem can be solved by forcing the Transmit Module to transmit at a data rate that is some constant multiple of the frame/pixel rate. The original frame/pixel rate can then be recreated in the Receive Module by dividing the receive data rate by that same constant.

This approach will not work in attempting to transport 2 or more video streams with a single link since each video stream will have a slightly different frame/pixel rate.

Thus, if the Transmit Module is set to transmit at a constant multiple of Video Stream 1, the Receive Module will be able to use Receive Data Rate and the selected constant to exactly recreate the pixel/frame rate for Video Stream 1. However, the Receive Module will not be able to exactly recreate the pixel/frame rate for Video Stream 2 since Video Stream 2 will always be slightly faster or slower (ex. Video Stream 1=60.001-Frames/Sec; Video Stream 2=60.002-Frames/Sec).

In a more general case, it is also useful to be able to transport 2 or more general data streams over a serial link where:
1. The data streams are asynchronous to each other.
2. Each data stream, including the stream clock and/or symbol timing, must be precisely reproduced by the receiver without inserting or deleting bits or symbols.

For example, it is useful in an audio/video production environment to transport a mix of audio and video streams on a single link where the streams are created by multiple capture devices that do not share a common reference clock. In this environment, it is essential that the captured data is not modified in any way during transport over the single link and that the asynchronous streams remain truly asynchronous until the producer decides to combine and synchronize them.

DisplayPort allows (but does not require) the transport of multiple uncompressed video streams (see section 2.1.2). However, this capability is created by a combination of inserting/removing symbols during the video blanking intervals and by sending time stamps along with the video data. The invention disclosed herein does not require either symbol insertion/removal or time stamps.

Similarly, prior art teaches how to transport a single video/data stream without inserting/removing symbols or adding timing information. However, this prior art does not teach how to recreate multiple asynchronous streams over a single link without inserting/removing symbols (in some cases whole frames) and without adding timing information to the video/data streams.

### BRIEF SUMMARY OF INVENTION

The disclosed invention provides a method and apparatus for transmitting a received data stream based exclusively on the arbitrary Received Data Rate (i.e. the original Receive Clock is not available) such that the Transmit Data Rate/Clock precisely matches the original Receive Data Rate/Clock. The present invention is useful in transporting two or more video, audio and general data streams over a single data link. The method aspect of the invention locks the transmit data rates for each data stream to arbitrary, respective receive data rates in a system that transports two or more video, audio or general data streams over a single data link.

The disclosed invention allows the Receive Module to recreate the pixel/frame rate for a Second Video Stream based exclusively on the data rate for that stream such that the pixel/frame rate for the Second Video Stream may be arbitrarily different from the pixel/frame rate for the First Video Stream transported over the same link. In fact, the disclosed invention allows the Receive Module to recreate the exact pixel/frame rates for N video streams transported by a single link based exclusively on the data rate for each of those Video Streams.

The method utilized by the invention disclosed is summarized as follows.

A method for locking transmit data rates to respective receive data rates in a system that transports two or more video, audio or general data streams over a single data link, comprising the steps:
buffering each of said data streams in a receive FIFO that is drained at a rate proportional to a transmit clock that is generated by a transmit oscillator,
monitoring the amount of data from each of said data streams stored in each receive FIFO,
converting the amount of data stored in each FIFO into either an analog voltage or numerical value,
filtering each of said voltages or numerical values to insure loop stability and responsiveness, and
using the outputs of each of said filters to control the transmit oscillator such that each of the respective transmit data rates for each data stream is exactly equal to the respective, arbitrary receive data rate.

The invention also provides a novel Buffer Locked Loop useful in transporting general data streams. As described below in greater detail, the Buffer Locked Loop essentially uses the depth of a FIFO to control a phase locked loop.

A primary object of the invention is to provide a method and apparatus for transporting two or more asynchronous video or general data streams over a single data link.

A further object is to provide a Buffer Locked Loop which is useful in transporting general data streams.

Further objects and advantages will become apparent from the following description and drawings.

### BRIEF DESCRIPTION OF THE DRAWINGS

FIG. 1 Buffer Locked Loop Block Diagram

FIG. 2 Multi-Stream Transport System Diagram

FIG. 3 Transmit Module

FIG. 4 Receive Module

### DETAILED DESCRIPTION OF THE INVENTION

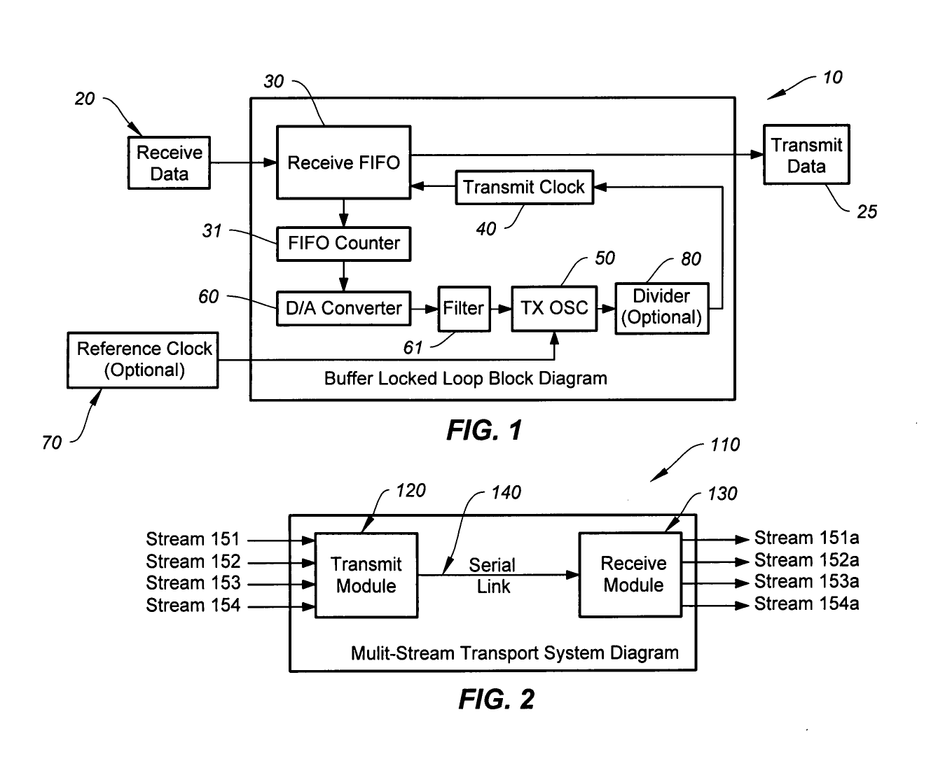

FIG. 1 is a buffer locked loop block diagram shown generally as 10. Data is supplied as receive data 20 at an arbitrary rate. The receive data 20 may be a video, audio or general data stream.

The received data 20 is buffered in Receive FIFO (First-In, First-Out) 30 that is drained at a rate that is proportional to a Transmit Clock 40 generated by a transmit oscillator 50. The transmit oscillator 50 may be a Voltage Controlled Oscillator that changes the Transmit Clock 40 based on voltage from filter 61, or may be a Current Controlled Oscillator that changes the Transmit Clock 40 based on current from the Filter 61. The transmit oscillator 50 may also be a Digital Controlled Oscillator that changes the Transmit Clock based on numerical values from the Filter 61. The type of transmit oscillator 50 (Voltage, Current or Digital) selected will be dictated by the specific requirements of the intended use. In all cases (Voltage, Current or Digital Controlled Oscillator), the transfer curve is selected to ensure loop stability and responsiveness using techniques common to someone skilled in the art.

The invention locks transmit data rate to an arbitrary receive data rate as follows.

A FIFO Counter 31 monitors the amount of data stored in the Receive FIFO 30. As data is buffered in the Receive FIFO the value of the FIFO Counter 31 will increase. The value of the FIFO Counter 31 will decrease as data is transmitted from the Receive FIFO 30.

The output of the FIFO Counter 31 is converted into either an analog voltage or current using a D/A Converter 60. As the FIFO Counter 31 increases (indicating more buffered data), the voltage/current from the D/A Converter 60 increases. As the FIFO Counter decreases (indicating less buffered data), the voltage/current from the D/A Converter decreases.

The output of the D/A Converter is filtered by filter 61 before it is sent to the transmit oscillator 50. The filter parameters are chosen to ensure loop stability and responsiveness using techniques common to someone skilled in the art.

Alternatively, the numerical values from the FIFO counter may be sent directly to the Filter 61 (bypassing the D/A converter 60). In this case, the numerical values would be filtered digitally in Filter 61 using techniques common to someone skilled in the art. The filter parameters would still be chosen to ensure loop stability and responsiveness using techniques common to someone skilled in the art.

The output of the Filter 61 is sent to the Control Input of the transmit oscillator 50.

The transmit oscillator 50 responds by increasing the Transmit Clock 40 rate in proportion to the transmit oscillator Control Input from the Filter 61. The transfer curve of the transmit oscillator is selected to ensure loop stability and responsiveness using techniques common to someone skilled in the art.

As the transmit oscillator Control Input increases (indicating more data buffered in the Receive FIFO), the Transmit Clock Rate will increase.

The increasing Transmit Clock Rate will drain the Receive FIFO 30 at an increasing rate until the Transmit Data Rate 25 matches the Receive Data Rate 20.

When the Transmit Data Rate matches the Receive Data Rate, the FIFO Counter 31 will remain constant.

At this point, the transmit oscillator 50 Control Input will stabilize. The disclosed Buffer Locked Loop 10 will now be locked such that the Transmit Data Rate 25 is exactly equal to the Receive Data Rate 20.

The buffer locked loop 10 of FIG. 1 has the novel and unique ability to create a Transmit Data Clock/Rate 25 that exactly matches the Receive Data Clock/Rate 20 based exclusively on the Receive Data Rate without using (or even having access to) the original Receive Data Clock (not shown).

FIGS. 2-4 illustrate how two or more data streams (specifically four data streams) are transported according to the invention.

FIG. 2 is a multi-stream transport system diagram 110 showing a Transmit Module 120 connected to a Receive Module 130 through a single data link 140. Four incoming asynchronous data streams 151-154 are fed into Transmit Module and transported over serial or single data link 140 to Receive Module 130. Incoming data streams 151-154 are reproduced exactly as outgoing data streams 151a-154a by Receive Module 130.

The buffer locked loop 10 of FIG. 1 also has the novel and unique ability to enable a Receive Module 130 to recreate the exact data/pixel/frame rates for N Data Video Streams transported by a single data link based exclusively on the data rate for each of those Data/Video Streams as shown in FIG. 2.

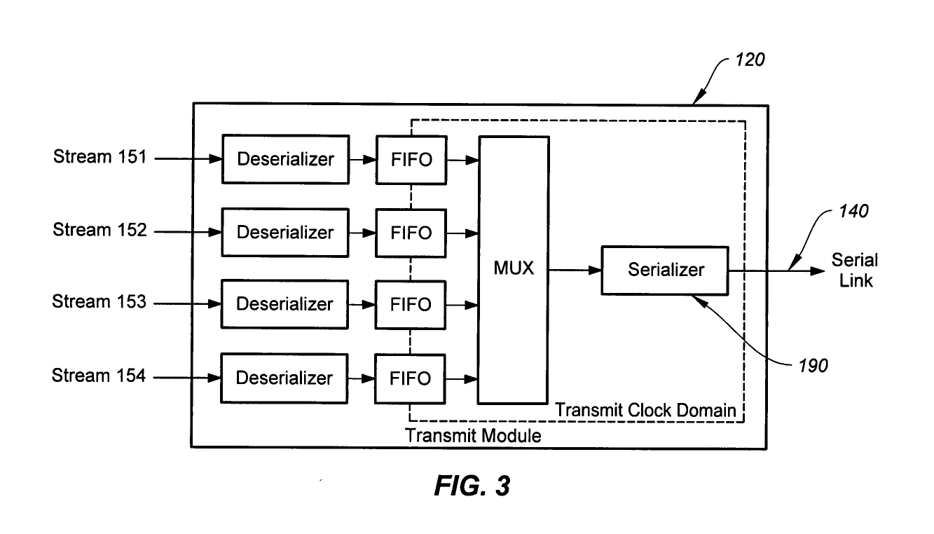

FIG. 3 illustrates Transmit Module 120 shown generally in FIG. 2.

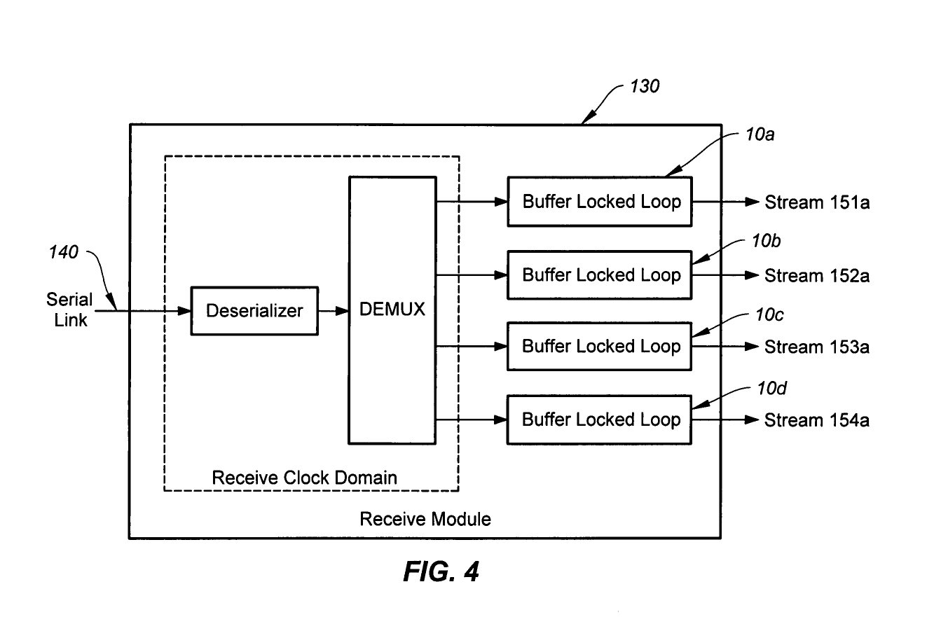

FIG. 4 illustrates Receive Module 130 shown generally in FIG. 2. Transmit Module 120 shown in FIG. 2 is connected to Receive Module 130 shown in FIG. 3 by serial (or single data) link 140. Four Buffer Locked Loops 10a-10d identical to loop 10 of FIG. 1 are utilized to accomplish the transport of output video, audio or general data streams 151a-154a as exact replicas of input video, audio or general data streams 151-154 as shown in FIGS. 2 and 3.

Various alternate, optional features may be added to the Buffer Locked Loop shown in FIG. 1. For example, a Reference Clock 70 may be supplied to the transmit oscillator 50 to improve oscillator performance. As a further example, the transmit oscillator 50 may use a crystal (not shown) to improve oscillator performance. Another example is that a programmable divider 80 may be used on the output of the transmit oscillator 50 to increase the operating range (in terms of data rate).

Another variation of Buffer Locked Loop 10 is to bypass the D/A Converter 60 so that the Filter 61 and transmit oscillator 50 may be implemented digitally.

A further alternative, as shown in FIG. 3, is where a serializer 190 is provided in Transmit Module 120 so the combined Data Streams 151-154 may be transmitted serially on Serial Link 140.

Another alternative is where the incoming Video Streams such as streams 151-154 shown in FIG. 3 are SDI (Serial Digital Interface).

The foregoing description of the invention has been presented for purposes of illustration and description and is not intended to be exhaustive or to limit the invention to the precise form disclosed. Modifications and variations are possible in light of the above teaching. The embodiments were chosen and described to best explain the principles of the invention and its practical application to thereby enable others skilled in the art to best use the invention in various embodiments suited to the particular use contemplated.

We claim:

1. A method for locking transmit data rates to arbitrary receive data rates in a system that transports two or more video, audio or general data streams over a single data link, comprising the steps:
buffering each of said data streams in a receive FIFO that is drained at a rate proportional to a transmit clock that is generated by a transmit oscillator,
monitoring the amount of data from each of said data streams stored in each receive FIFO,
converting the amount of data stored in each FIFO into either an analog voltage/current or numerical value,
filtering each said voltage/current or numerical value to insure loop stability and responsiveness, and
using the output of said filter to control the transmit oscillator such that the transmit data rate for each data stream is exactly equal to the respective receive data rate.

2. The method of claim 1 wherein a reference clock is supplied to said transmit oscillator.

3. The method of claim 1 wherein said transmit oscillator uses a crystal to Improve oscillator performance.

4. The method of claim 1 wherein a programmable divider is used on the output of said transmit oscillator to increase the operating range in terms of data rate.

5. The method of claim 1 wherein said data streams are video streams and wherein said video streams are SDI (Serial Digital Interface).

6. The method of claim 1 wherein each of said data streams is precisely reproduced by said receiver module without inserting or deleting bits of symbols.

7. The method of claim 1 wherein said transmit oscillator is a Voltage Controlled Oscillator.

8. The method of claim 1 wherein said transmit oscillator is a Current Controlled Oscillator.

9. The method of claim 1 wherein said transmit oscillator is a Digital Controlled Oscillator.

10. Apparatus for locking transmit data rates to respective, arbitrary receive data rates in a system that transports two or more asynchronous video, audio or general data streams over a single data link, comprising:
means for buffering each of said data streams in a receive FIFO that is drained at a rate proportional to a transmit clock that is generated by a transmit oscillator,
means for monitoring the amount of data from each of said data streams stored in each receive FIFO,
means for converting the amount of data stored in each said FIFO into either an analog voltage/current or numerical value,
means for filtering each of said voltages, currents or numerical values to insure loop stability and responsiveness, and
means for using the outputs of each of said filters to control the transmit oscillator such that each of the transmit data rates is exactly equal to the respective, arbitrary receive data rates.

11. The apparatus of claim 10 wherein said transmit oscillator is a Voltage Controlled Oscillator.

12. The apparatus of claim 10 wherein said transmit oscillator is a Current Controlled Oscillator.

13. The apparatus of claim 10 wherein said transmit oscillator is a Digital Controlled Oscillator.
